(19) United States
(12) Patent Application Publication
(10) Pub. No.: US 2006/0192777 A1
(43) Pub. Date: Aug. 31, 2006

(54) Method and apparatus for displaying three-dimensional video

(75) Inventors: Takashi Matsubara, Kanagawa (JP); Makoto Furuki, Kanagawa (JP); Satoshi Tatsuura, Kanagawa (JP); Izumi Iwasa, Kanagawa (JP); Yasuhiro Sato, Kanagawa (JP); Minquan Tian, Kanagawa (JP); Hiroyuki Mitsu, Tokyo (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/218,475

(22) Filed: Sep. 6, 2005

(30) Foreign Application Priority Data
Feb. 28, 2005 (JP) P.2005-054223

(51) Int. Cl. G06T 15/00

(52) U.S. Cl. 345/419

(57) ABSTRACT

A three-dimensional video display method includes a first step of causing a first optical pulse to enter a fluorescent space from a predetermined direction, and a second step of causing a second optical pulse, into which cross-sectional information is written, to enter the fluorescent space from a direction opposite to the predetermined direction, to induce fluorescence at a position in the fluorescent space where the first optical pulse and the second optical pulse overlap each other.

### BACKGROUND OF THE INVENTION

1. Field of the Invention

The present invention relates to a method and apparatus for displaying a three-dimensional video within a fluorescent space through use of an optical pulse.

2. Description of the Related Art

In the field of a medical CT system, a CAD system, or the like, there is increasing demand for a three-dimensional display which displays a large volume of three-dimensional information at high speed.

Many related-art three-dimensional video display methods are for displaying a pseudo three-dimensional image on a two-dimensional plane. For instance, three-dimensional CG (Computer Graphics) represents a three-dimensional solid by means of shading or gradations in color density. Namely, the method provides a pseudo three-dimensional image expression on a two-dimensional plane.

Another three-dimensional video display method is for inducing stereoscopic parallax by causing the left and right eyes to view different images on a two-dimensional display through deflection glasses, or the like, to thus provide a three-dimensional appearance. However, the method encounters problems of limitations imposed on viewpoints or fatigue arising from prolonged usage of the display. A three-dimensional display method using a holography technique is also available. However, this method also encounters problems of creation of a hologram involving consumption of much time, the method being limited solely to a stationary image, and the like.

For these reasons, demand for an apparatus which actually displays a three-dimensional video within a three-dimensional space is currently increasing. Methods for actually displaying a three-dimensional video within a three-dimensional space include, specifically, a volume scan method (a depth sampling method). More specifically, the methods include (a) a varifocal mirror method, (b) a mobile display method, and (c) a moving screen method.

(a) is a method for reflecting a two-dimensional image in synchronism with back-and-forth oscillation of a concave mirror. (b) is a method for displaying a three-dimensional video by moving or rotating, at high speed, a cross-sectional image of a three-dimensional video through use of a light-emitting diode display, or the like. (c) is a method for providing a three-dimensional appearance by projecting a cross-sectional profile of a three-dimensional image on a moving screen.

Another method (d) differing from the above-described methods is also available. Under this method, two two-dimensional laser arrays are arranged at right angles, and fluorescence is caused at a point of intersection of two laser beams, to thus display an image in a three-dimensional space (see, e.g., JP-A-5-224608).

However, techniques (a) to (c) entail problems. Specifically, the varifocal mirror method (a) involves the problems of: limitations on the size of an image which can be expressed by the method, and a necessity for making the concave mirror large when many people are to view an image. The mobile display method (b) and the moving screen method (c) involve the problems of: limitations being imposed on the range of angle from which a three-dimensional video is viewable, depending on a moving direction, variations in resolution, and an image being likely to be blurred.

Under technique (d), infrared light is used as a laser beam. Two laser beams are absorbed little by little as the laser beams travel through the inside of a display medium, whereby the intensity of light is attenuated. Therefore, a part of an image close to the laser arrays becomes bright, and the opposite side of the image becomes dark. When the size of a display medium is increased, this phenomenon becomes more noticeable.

### SUMMARY OF THE INVENTION

The present invention provides a three-dimensional video display method and apparatus, which enable display of a uniform, clear, three-dimensional video without limitations on viewable directions.

According to an aspect of the present invention, a three-dimensional video display method includes a first step of causing a first optical pulse to enter a fluorescent space from a predetermined direction, and a second step of causing a second optical pulse, into which cross-sectional information is written, to enter the fluorescent space from a direction opposite to the predetermined direction, to induce fluorescence at a position in the fluorescent space where the first optical pulse and the second optical pulse overlap each other.

According to an aspect of the present invention, a three-dimensional video display apparatus includes a first optical pulse entrance unit that causes a first optical pulse to enter a fluorescent space from a predetermined direction, and a second optical pulse entrance unit that causes a second optical pulse, into which cross-sectional information has been written, to enter the fluorescent space from a direction opposite to the predetermined direction, to induce fluorescence at a position within the fluorescent space where the first optical pulse and the second optical pulse overlap each other.

### BRIEF DESCRIPTION OF THE DRAWINGS

Embodiments of the present invention will be described in detail based on the following figures, wherein:

FIG. 1 is a view showing the principle of a three-dimensional video display method according to the present invention;

FIG. 2 is a first view showing the principle of fluorescence being caused by multi-photon absorption;

FIG. 3 is a second view showing the principle of fluorescence being caused by multi-photon absorption;

FIG. 4 is a third view showing the principle of fluorescence being caused by multi-photon absorption;

FIG. 5 is a fourth view showing the principle of fluorescence being caused by multi-photon absorption;

FIG. 6 is a fifth view showing the principle of fluorescence being caused by multi-photon absorption;

FIG. 7 is a view showing a three-dimensional video display method according to a first mode of the present invention;

FIG. 8 is a view showing a three-dimensional video display method according to a second mode of the present invention;

FIG. 9 is a view showing a three-dimensional video display method according to a third mode of the present invention;

FIG. 10 is a view showing a three-dimensional video display method according to a fourth mode of the present invention;

FIG. 11 is a view showing a three-dimensional video display apparatus according to a first embodiment of the present invention;

FIG. 12 is a view showing rotary mirror sections according to the first embodiment of the present invention;

FIG. 13 is an example of cross-sectional information to be written into each of optical pulses;

FIG. 14 is an example of three-dimensional video appearing in a fluorescent space;

FIG. 15 is a view showing a three-dimensional video display apparatus according to a second embodiment of the present invention;

FIG. 16 is a view showing a three-dimensional video display apparatus according to a third embodiment of the present invention;

FIG. 17 is a view showing a three-dimensional video display apparatus according to a fourth embodiment of the present invention; and

FIG. 18 is a view showing a three-dimensional video display apparatus according to a fifth embodiment of the present invention.

### DETAILED DESCRIPTION OF THE INVENTION

[Principle of the Invention]

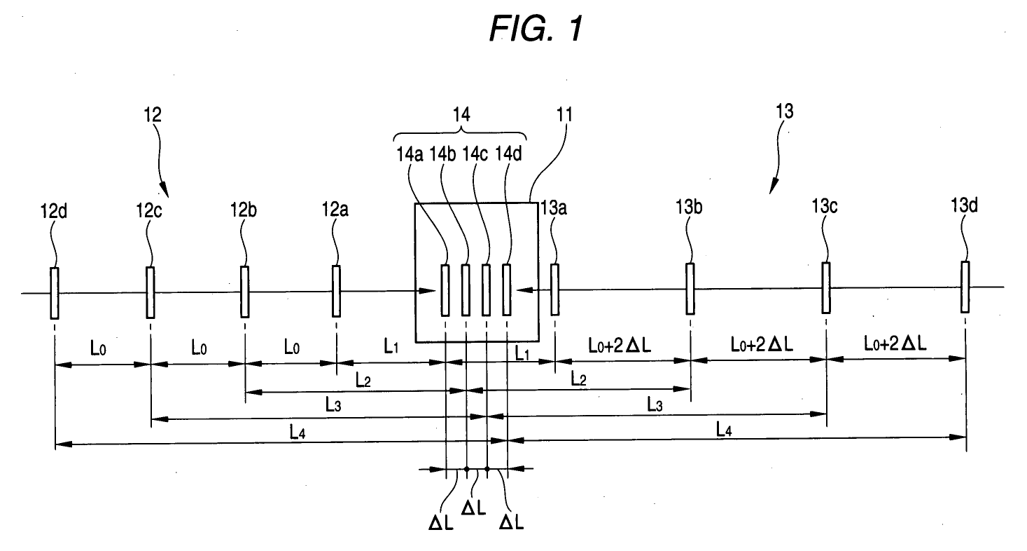

FIG. 1 shows a configuration for describing a basic principle of a three-dimensional video display method according to the present invention. In FIG. 1, a first optical pulse 12 and a second optical pulse 13 are caused to enter a fluorescent space 11 in opposite directions along a single optical axis penetrating through the fluorescent space 11.

The fluorescent space 11 is filled with a fluorescent substance or a fluorescent-substance-containing gas, liquid, or solid. A substance exhibiting a high two-photon fluorescence efficiency, such as a two-photon fluorescent pigment, is desirable. A Rhodamine pigment, a Fluorescein pigment, a DiI pigment, or a Courmarin pigment can be used as a pigment which is generally known as having high two-photon fluorescence efficiency. Other pigments which exhibit high two-photon fluorescence efficiencies and which are described in JP-A-2004-123668, JP-A-2004-224746, JP-A-2001-520637, and JP-A-2004-29480 can also be applied to the present invention.

When the first optical pulse 12 has entered the fluorescent space 11 from one side thereof and the second optical pulse 13 has entered the same from the other side thereof, the first optical pulse 12 and the second optical pulse 13 overlap each other. The fluorescent substance induces multi-photon absorption more intensively at a location where the overlap has arisen than at a location where the first optical pulse 12 and the second optical pulse 13 do not overlap each other. Fluorescence is emitted during a course of excited electrons being released. Therefore, a cross-sectional image of desired profile is displayed in the fluorescent space 11 by fluorescence by means of adjusting a profile acquired at the location where the first optical pulse 12 and the second optical pulse 13 overlap each other.

As shown in FIG. 1, first optical pulses 12a, 12b, 12c, 12d, . . . are assumed to have entered the fluorescent space 11 at a given repetitive cycle (interval L₀), and second optical pulses 13a, 13b, 13c, 13d, . . . are assumed to have entered the fluorescent space 11 at a given repetitive cycle (interval L₀+2ΔL) differing from that at which the first optical pulse 12 has entered. Under these assumptions, cross-sectional images are to be displayed at different locations, because the first optical pulse 12 and the second optical pulse 13 differ from each other in terms of entrance timing. In FIG. 1, L1 to L4 denote distances to locations where the first optical pulse 12 and the second optical pulse 13 overlap each other, and ΔL denotes an interval between cross-sectional images.

When the first optical pulse 12a and the second optical pulse 13a overlap each other within the fluorescent space 11, to thus display a cross-sectional image 14a. Similarly, the first optical pulse 12b and the second optical pulse 13b display a cross-sectional image 14b, the first optical pulse 12c and the second optical pulse 13c display a cross-sectional image 14c, and the first optical pulse 12d and the second optical pulse 13d display a cross-sectional image 14d. The four cross-sectional images 14a to 14d, which are spaced apart from each other by the interval of ΔL, display a single three-dimensional video 14 within the fluorescent space 11. Although the respective cross-sectional images 14a to 14d differ from each other in fluorescence timing, the human eye ascertains the cross-sectional images as if they were displayed simultaneously, by virtue of an after-image phenomenon. Consequently, these cross-sectional images 14a to 14d are displayed as the single three-dimensional video 14, which is a combination of the cross-section images.

In order to impart a desired profile to the cross-sectional image, a profile acquired at the location where the cross sections of the two optical pulses 12, 13 overlap each other must be formed into a desired shape. Specifically, the cross-sectional profile of the first optical pulse 12 is formed into a shape which falls within a given range within the fluorescent space 11, and the cross-sectional profile of the second optical pulse 13 is formed into a desired cross-sectional profile. As a result, the cross-sectional profile of the second optical pulse 13 is displayed within the fluorescent space 11. Moreover, a desired three-dimensional video is obtained by changing the cross-sectional profile of the second optical pulse 13 in accordance with the position where the cross-sectional image is to be displayed.

(Principle of Fluorescence)

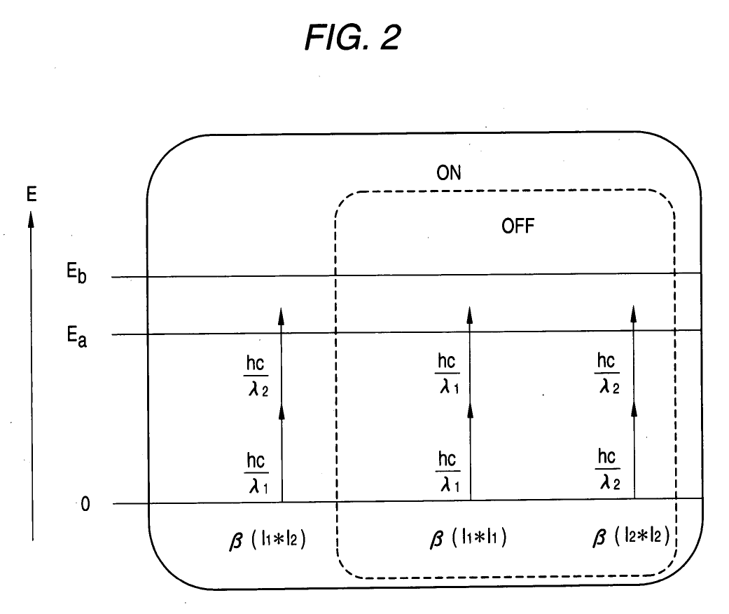

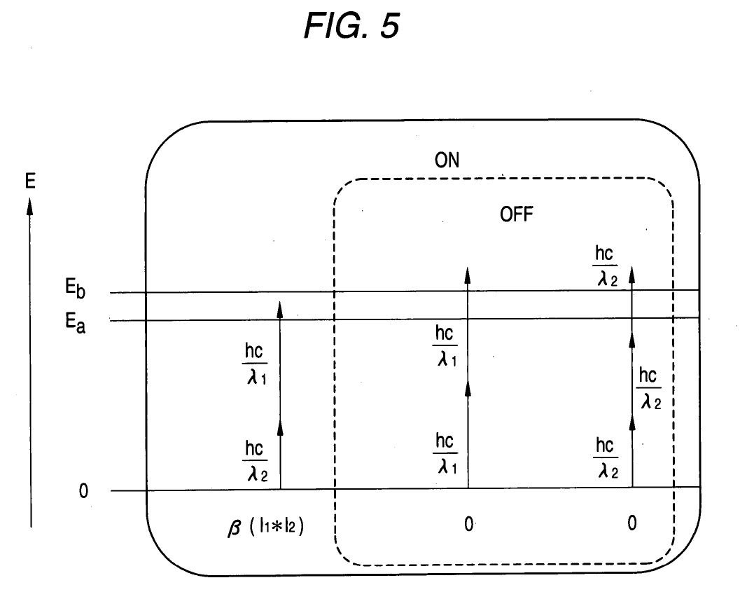

The principle of fluorescence arising from multi-photon absorption will now be described by reference to FIGS. 2 to 6. The three-dimensional video display method of the present invention is to superimpose two optical pulses one on the other within the fluorescent space to thus induce fluorescence solely at the position of the overlap, thereby effecting a display within a three-dimensional space. In order to achieve a clear three-dimensional video, a high ON/OFF ratio between a location where fluorescence arises and a location where no fluorescence arises is sought. The present invention enables acquisition of a high ON/OFF ratio by selecting the wavelength of an optical pulse and multi-photon absorption energy of a fluorescent substance. Here, the ON/OFF ratio signifies a fluorescence intensity ratio between a location where the first optical pulse 12 and the second optical pulse 13 overlap each other and a location where no overlap exists.

The wavelength of the first optical pulse 12 is assumed to be λ₁, the light intensity of the same is assumed to be I₁, the wavelength of the second optical pulse 13 is assumed to be λ₂, the light intensity of the same is assumed to be I₂, and the second optical pulse 13 is assumed to be an optical pulse train. Under these assumptions, the number of optical pulses included in an optical pulse train is assumed to be N, and the excitation energy of the fluorescent substance is assumed to fall within a range of Ea to Eb. Now, in order to induce intensive fluorescence solely at a location where the first optical pulse 12 and the second optical pulse 13 overlap each other, the following expressions must be satisfied.

$$\begin{matrix}{E}_{a} \leq \frac{hc}{{λ}_{1}} + \frac{hc}{{λ}_{2}} \leq Eb & Expression ( 1 ) \\ \frac{hc}{{λ}_{1}} \leq {E}_{a} & Expression ( 2 ) \\ \frac{hc}{{λ}_{2}} \leq {E}_{a} & Expression ( 3 )\end{matrix}$$

When Expressions (1), (2), and (3) are satisfied, two-photon absorption arises at a location where the first optical pulse 12 and the second optical pulse 13 overlap each other. Here, “c” denotes the speed of light, and “h” denotes Planck's constant.

Moreover, when the following expressions are satisfied

$$\frac{hc}{{λ}_{1}} \leq {E}_{a} \leq 2 \frac{hc}{{λ}_{1}} \leq {E}_{b} \frac{hc}{{λ}_{2}} \leq {E}_{a} \leq 2 \frac{hc}{{λ}_{2}} \leq {E}_{b} \qquad Expression ( 4 )$$

(see FIG. 2), the intensity of fluorescence is proportional to the magnitude of absorption, on the assumption that a two-photon absorption constant of the fluorescent substance achieved when the excitation energy falls within the range of Ea to Eb is β. Accordingly, the fluorescence intensity ratio (On/Off ratio) between the location where the first optical pulse 12 and the second optical pulse 13 overlap each other and a location where no overlap exists is expressed as follows:

$$\begin{matrix}On \text{/} Off = \frac{β ( {I}_{1} {I}_{2} ) \times 2 + β ( {I}_{2} {I}_{2} ) + β ( {I}_{1} {I}_{1} ) \times N}{β ( {I}_{1} {I}_{1} ) + β ( {I}_{2} {I}_{2} ) \times N} \\ = \frac{β ( {I}_{1} {I}_{2} ) \times 2}{β ( {I}_{1} {I}_{1} ) + β ( {I}_{2} {I}_{2} ) \times N} + 1\end{matrix} \qquad Expression ( 5 )$$

A maximum value of 2 is acquired when N=1, I₁=I₂. The ON/OFF ratio becomes lower as N increases.

Moreover, when the following expressions are satisfied

$$\frac{hc}{{λ}_{1}} \leq {E}_{a} \leq 2 \frac{hc}{{λ}_{1}} \leq {E}_{b} 2 \frac{hc}{{λ}_{2}} \leq {E}_{a} \leq 3 \frac{hc}{{λ}_{2}} \leq {E}_{b} \qquad Expression ( 6 )$$

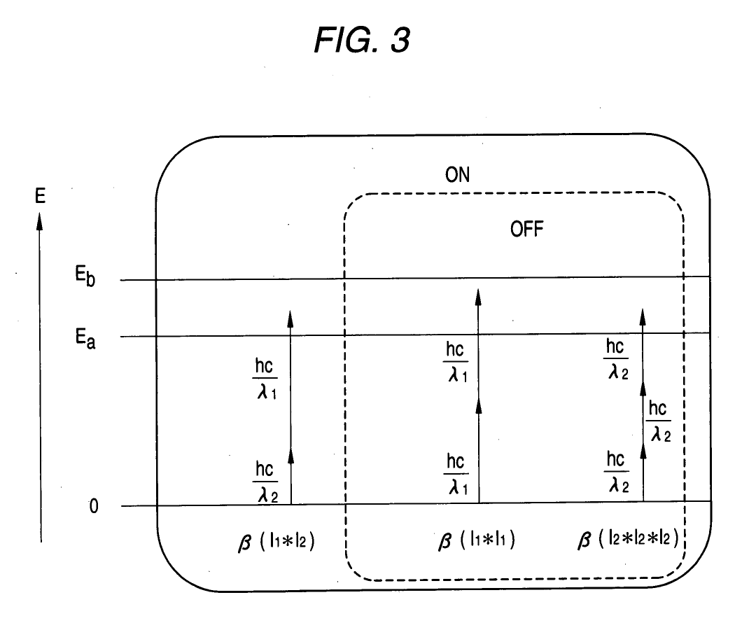

(see FIG. 3), the following expression stands on condition that a three-photon absorption constant of the fluorescent substance achieved when three-photon absorption energy falls within the range of Ea to Eb is γ.

$$\begin{matrix}On \text{/} Off = \frac{β ( {I}_{1} {I}_{2} ) \times 2 + β ( {I}_{1} {I}_{3} ) + γ ( {I}_{2} {I}_{2} {I}_{2} ) \times N}{β ( {I}_{1} {I}_{1} ) + γ ( {I}_{2} {I}_{2} {I}_{2} ) \times N} \\ = \frac{β ( {I}_{1} {I}_{2} ) \times 2}{β ( {I}_{1} {I}_{1} ) + γ ( {I}_{2} {I}_{2} {I}_{2} ) \times N} + 1 \\ = \frac{2 {I}_{2}}{{I}_{1}} + 1\end{matrix} \qquad Expression ( 7 )$$

where β(I₁I₁)>>γ(I₂I₂I₂)×N. In a range where three-photon absorption caused by the second optical pulse 13 is negligibly small, the ON/OFF ratio becomes greater if
I₁<I₂ . . . Expression (8)

Moreover, when the following expressions are satisfied

$$\frac{hc}{{λ}_{1}} \leq {E}_{a} \leq {E}_{b} \leq 2 \frac{hc}{{λ}_{1}} 2 \frac{hc}{{λ}_{2}} \leq {E}_{a} \leq 3 \frac{hc}{{λ}_{2}} \leq {E}_{b} \qquad Expression ( 9 )$$

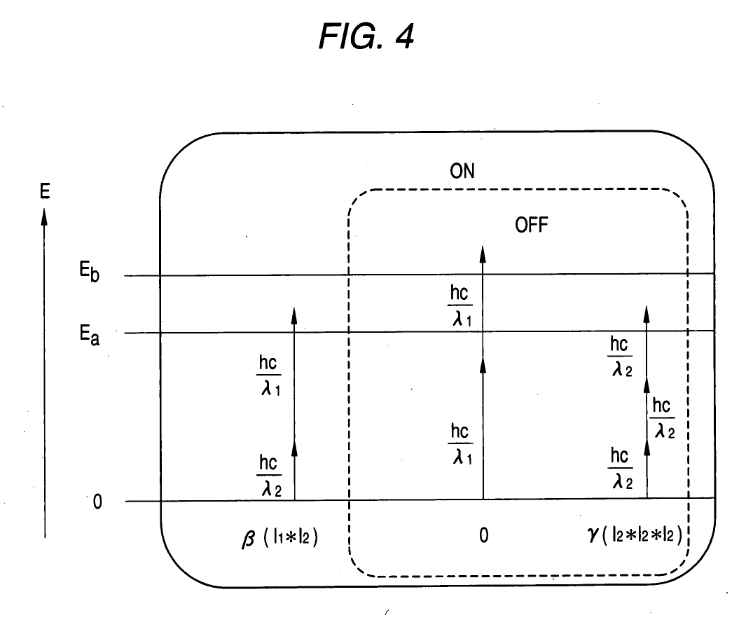

(see FIG. 4), the ON/OFF ratio is defined as

$$\begin{matrix}On \text{/} Off = \frac{β ( {I}_{1} {I}_{2} ) \times 2 + γ ( {I}_{2} {I}_{2} {I}_{2} ) \times N}{γ ( {I}_{s} {I}_{2} {I}_{2} ) \times N} \\ = \frac{β ( {I}_{1} ) \times 2}{γ ( {I}_{2} {I}_{2} ) \times N} + 1\end{matrix} \qquad Expression ( 10 )$$

Since β>>γ, the ON/OFF ratio becomes much greater than that defined by Expression (7).

Moreover, when the following expressions are satisfied

$$\begin{matrix}\frac{hc}{{λ}_{1}} \leq {E}_{a} \leq {E}_{b} \leq 2 \frac{hc}{{λ}_{1}} 2 \frac{hc}{{λ}_{2}} \leq {E}_{a} \leq {E}_{b} \leq 3 \frac{hc}{{λ}_{2}} \\ ( see FIG . 5 ) or & Expression ( 11 ) \\ \frac{hc}{{λ}_{1}} \leq {E}_{a} \leq {E}_{b} \leq 2 \frac{hc}{{λ}_{1}} 3 \frac{hc}{{λ}_{2}} \leq {E}_{a} \leq {E}_{b} & Expression ( 12 )\end{matrix}$$

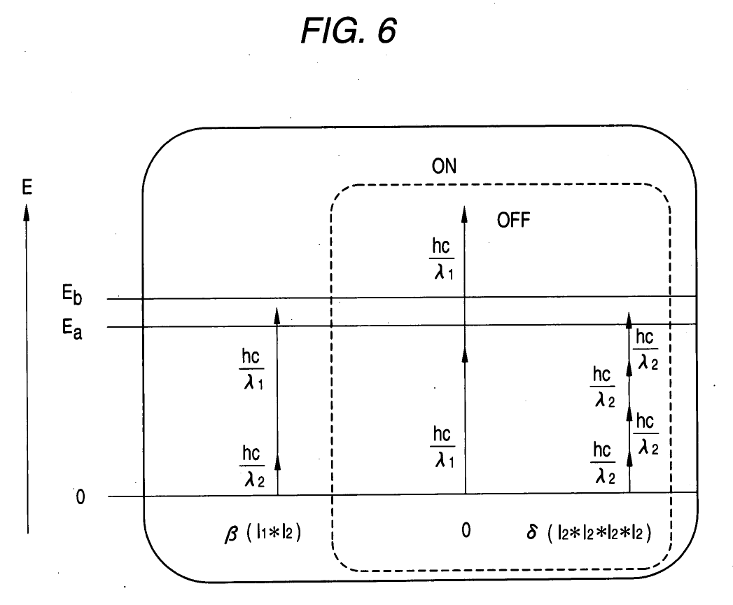

(see FIG. 6), the ON/OFF ratio becomes essentially zero, because multi-photon absorption hardly arises in a location where no overlap exists between the optical pulses.

In order to achieve a high ON/OFF ratio, a relationship between the fluorescent substance and the optical pulse desirably satisfies Expressions (1), (2), (3), (6), and (8). More preferably, the relationship satisfies Expressions (1), (2), (3), and (9). Further preferably, the relationship satisfies Expressions (1), (2), (3), and (11), or Expressions (1), (2), (3), and (12).

In order to achieve a more clear three-dimensional video, a high fluorescence efficiency is required in addition to the high ON/OFF ratio. The fluorescence efficiency arising as a result of the first optical pulse 12 and the second optical pulse 13 overlapping each other is proportional to the following expression.
ΦβI₁·I₂ Expression (13)
In addition to satisfying Expressions (1), (2), (3), (6), and (8) or Expressions (1), (2), (3), and (9), the two-photon absorption coefficient β of the fluorescent substance and the intensity I₁·I₂ of the optical pulse must be large. Here, Φ denotes the quantum efficiency of the fluorescent substance.

As mentioned above, in order to display one of the cross-sectional images forming the three-dimensional video 14 at a desired position within the fluorescent space 11, entrance timing of the first optical pulse 12 and that of the second optical pulse 13 must be adjusted. A three-dimensional video display method according to modes of the present invention will be described more specifically hereinbelow.

[First Mode]

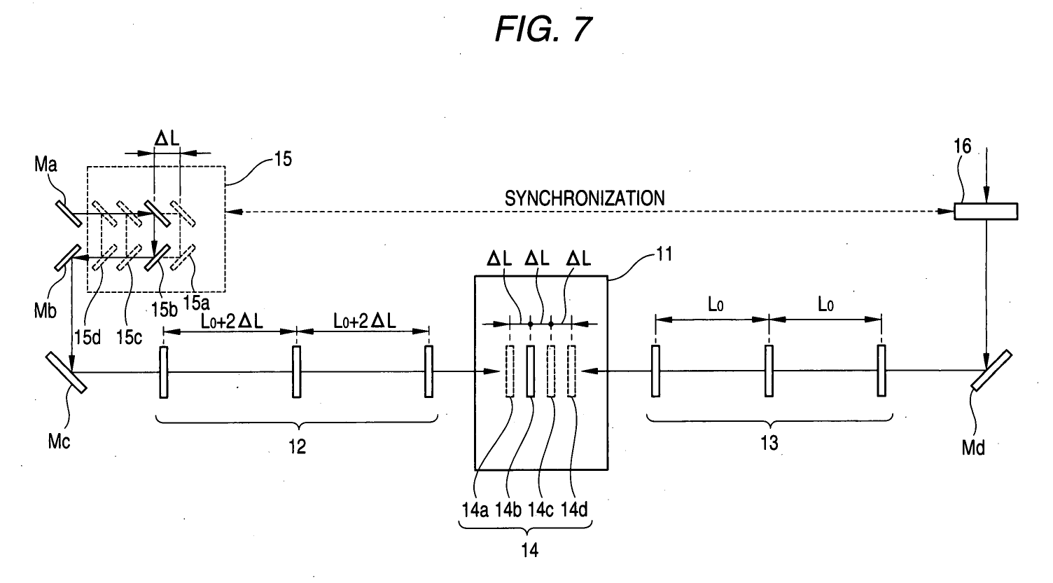

FIG. 7 shows a three-dimensional video display method according to a first mode of the present invention. An apparatus used for the three-dimensional video display method of the first mode includes an unillustrated pulse light source which emits the first optical pulse 12 and the second optical pulse 13 at a given repetitive cycle (interval L₀), an optical path length control mechanism 15 which changes the optical path length of the first optical pulse 12 emitted from the pulse light source to thus generate the first optical pulse 12 of given repetitive cycle (interval L₀+2ΔL) and which causes the first optical pulse 12 to enter the fluorescent space 11 from one side thereof, a space light modulation section 16 which writes cross-sectional information corresponding to a cross-sectional image signal into the second optical pulse 13 emitted from the pulse light source and which causes the second optical pulse 13 to enter the fluorescent space 11 from the other side thereof, and an unillustrated control section for controlling individual sections of the apparatus. In the drawings, reference symbols “Ma” to “Md” denote reflection mirrors.

The optical path length control mechanism 15 adjusts the optical path length over which the first optical pulse 12 travels from the pulse light source (not shown) to the fluorescent space 11 by means of control operation of the control section. By means of adjustment of this optical path length, a difference between the optical path lengths of the two optical pulses 12, 13 changes, which in turn changes the entrance timings of the optical pulses.

Specifically, switching mirrors 15a to 15d, each consisting of a pair of mirrors, are arranged at an interval ΔL equal to an interval ΔL between the cross-sectional images 14a to 14d. Any one of the switching mirrors 15a to 15d is selected, and the optical pulse is reflected by means of the thus-selected switching mirror. At this time, the optical path length varies depending on the thus-selected switching mirror.

FIG. 7 is based on the assumption that the apparatus has four switching mirror pairs 15a to 15d. However, no limitation is imposed on the number of switching mirrors. Moreover, the switching mirrors are given reference numerals 15a, 15b, 15c, and 15d in descending order from the switching mirror providing the longest optical path length.

The space light modulator 16 can be embodied by use of a liquid-crystal space light modulator. A voltage applied to respective pixels of the liquid-crystal space light modulator is controlled in accordance with the cross-sectional image signal, to thus generate the second optical pulse 13 having an optical pattern corresponding to a cross-sectional image signal and write cross-sectional information into the second optical pulse 13. Fluorescence arises in portions of the optical pulses corresponding to the cross-sectional information, at the location in the fluorescent space 11 where the first optical pulse 12 and the second optical pulse 13 have overlapped each other, thereby acquiring a desired cross-sectional image. A micromirror array can also be used as a space light modulator.

The timing at which the optical path length is changed by the optical path length control mechanism 15 and the timing at which the cross-sectional information is written by the space light modulation section 16 are controlled by an unillustrated control section so as to synchronize with each other.

(Display Operation Effected in the First Mode)

The optical path length of the first optical pulse 12a becomes longest when the unillustrated control section selects the switching mirror 15a by means of the optical path length control mechanism 15 to thus cause the unillustrated pulse light source to emit the first optical pulse 12a and the second optical pulse 13a at the same timing. Accordingly, the time at which the first optical pulse 12a arrives at the fluorescent space 11 is most delayed. Consequently, the location where the first optical pulse 12a and the second optical pulse 13a overlap each other comes to the left of the fluorescent space 11, so that the cross-sectional image 14a appears.

Next, the switching mirror 15b is selected by the optical path length control mechanism 15. When the first optical pulse 12b and the second optical pulse 13b are emitted at the same timing, the first optical pulse 12b travels via the optical path length control mechanism 15. As a result, the optical path length of the first optical pulse 12b is adjusted, whereby the timing at which the first optical pulse 12b arrives at the fluorescent space 11 is adjusted. Consequently, the cross-sectional image 14b appears at the location where the two optical pulses 12b, 13b overlap each other.

Similarly, when the switching mirror 15c or 15d is selected by the optical path length control mechanism 15, the optical path lengths are further shortened. Accordingly, the time at which the first optical pulse 12 arrives at the fluorescent space 11 becomes faster, and the location where the two optical pulses 12, 13 overlap each other shifts from a direction in which the second optical pulse 13 enters, so that the cross-sectional image 14c or 14d appears. In the end, the three-dimensional video 14 consisting of the cross-sectional images 14a to 14d appears.

According to the first mode, only one space light modulator is required. Therefore, display of a clear three-dimensional video having uniform resolving power and brightness can be effected by means of a simple configuration and without limitations on a viewable direction.

[Second Mode]

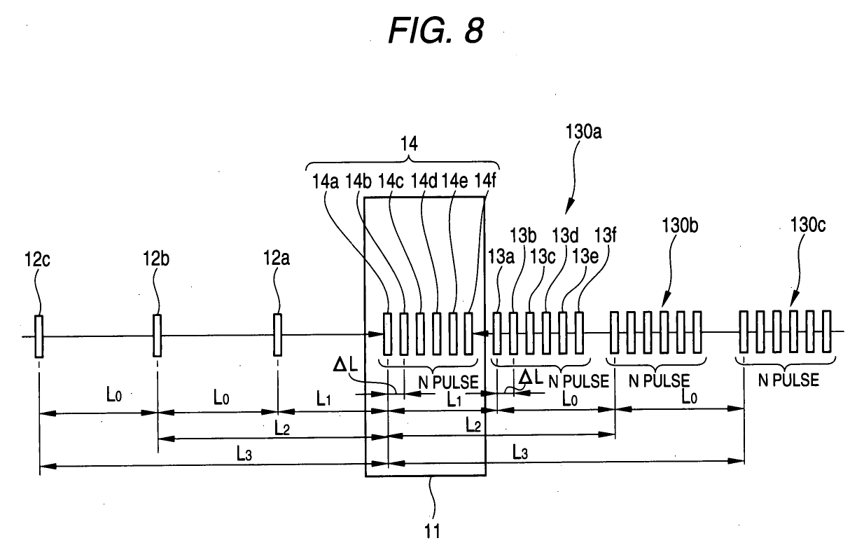

FIG. 8 shows a three-dimensional video display method according to a second mode of the present invention. The three-dimensional video display method of the second mode is for causing the first optical pulses 12a, 12b, 12c, . . . to enter the fluorescent space 11 from one side thereof at a given repetitive cycle (interval L₀), and causing optical pulse trains 130a, 130b, 130c, . . . formed from N second optical pulses 13a to 13f to enter the fluorescent space 11 from the other side thereof at the same repetitive cycle (interval L₀) as that at which the first optical pulses enter, to thus display the three-dimensional video 14 consisting of N cross-sectional images 14a to 14f. In FIG. 8, reference symbols L₁ to L₃ designate distances to locations where the first optical pulses 12a, 12b, and 12c and the second optical pulses 13a—which are the heads of the respective optical pulse trains 130a, 130b, and 130c—overlap one another, and reference symbol ΔL denotes an interval between the cross-sectional images.

Cross-sectional information is written into the N second optical pulses 13a to 13f by means of N separate optical axes with the space light modulator, and the optical pulses enter the fluorescent space 11 from the other side thereof.

(Display Operation Effected in the Second Mode)

The first optical pulses 12a, 12b, 12c, . . . enter the fluorescent space 11 from one side thereof at a predetermined timing, and optical pulse trains 130a, 130b, 130c, . . . consisting of the N (six in FIG. 8) second optical pulses 13a to 13f enter the fluorescent space 11 from the other side thereof at a predetermined timing.

As a result of the first optical pulse 12 and the optical pulses 13a to 13f of the optical pulse train 130 overlapping each other, the cross-sectional images 14a to 14f appear at the position where the pulses overlap each other. The three-dimensional video 14 is displayed by means of one optical pulse 12 and one optical pulse train 130 or by means of M optical pulses 12 and M optical pulse trains 130. When the three-dimensional video 14 is displayed by means of one optical pulse 12 and one optical pulse train 130, the cross-sectional information to be written into the respective optical pulse trains 130 is changed in terms of time, so that a motion display becomes feasible.

According to the second mode, a three-dimensional motion picture can be displayed by rewriting the cross-sectional information on a per-optical-pulse-train basis. Moreover, as in the case of the first embodiment, a uniform, clear, three-dimensional video can be displayed without limitations on a viewable direction.

[Third Mode]

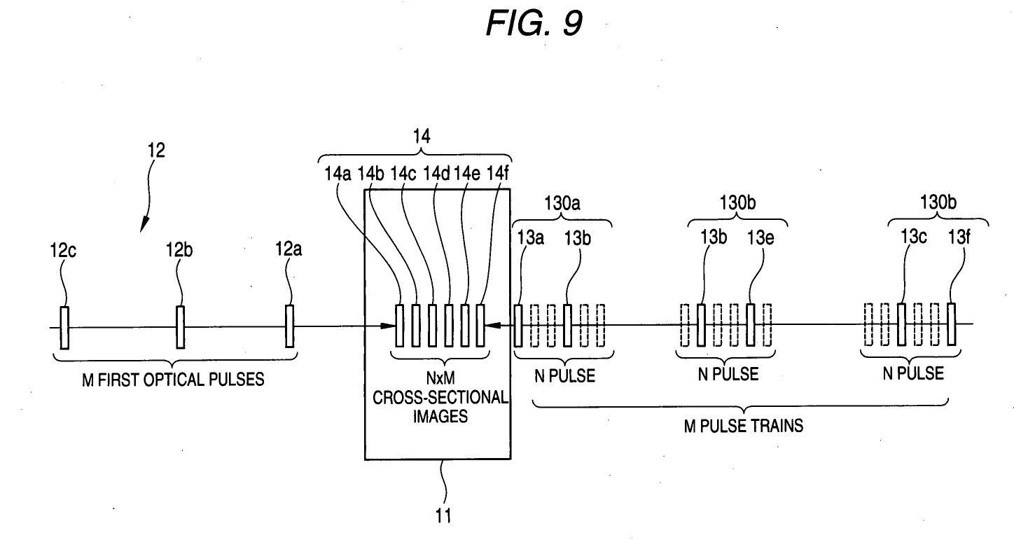

FIG. 9 shows a three-dimensional video display method according to a third mode of the present invention. The three-dimensional video display method of the third mode is for causing M of the first optical pulses 12 to enter the fluorescent space 11 from one side thereof at a given repetitive cycle, and causing M of the optical pulse trains 130 formed from N (two in this embodiment) of the second optical pulses 13a to 13f to enter the fluorescent space 11 from the other side thereof at a predetermined timing, to thus display the three-dimensional video consisting of N×M of cross-sectional images.

(Display Operation Effected in the Third Mode)

M (three in FIG. 9) first optical pulses 12a, 12b, 12c, . . . are caused to enter the fluorescent space 11 from one side thereof at a predetermined timing, and M (three in FIG. 9) of the optical pulse trains 130a, 130b, 130c, . . . , each of which is formed from N (two in FIG. 9) of the second optical pulses 13, to enter the fluorescent space 11 from the other side thereof at a predetermined timing.

When the first optical pulse train 130a, which consists of the two second optical pulses 13a, 13d, enters the fluorescent space 11 in synchronism with the timing at which the initial first optical pulse 12a enters the fluorescent space 11, two cross-sectional images 14a, 14d appear at the position where the first optical pulse 12a and the second optical pulses 13a, 13d overlap each other. When the second optical pulse train 130b, which consists of the two second optical pulses 13b, 13e, enters the fluorescent space 11 in synchronism with the timing at which the next first optical pulse 12b enters the fluorescent space 11, the two cross-sectional views 14b, 14d appear at the position where the first optical pulse 12b and the second optical pulses 13b, 13e overlap each other. When the third optical pulse train 130c, which consists of the two second optical pulses 13c, 13f, enters the fluorescent space 11 in synchronism with the timing at which the one-after-the-next first optical pulse 12c enters the fluorescent space 11, two cross-sectional images 14c, 14f appear at the position where the first optical pulse 12c and the second optical pulses 13c, 13f overlap each other. Finally, a single three-dimensional video 14, which is a combination of these cross-sectional images, appears. The respective cross-sectional images are displayed in different positions, and a single three-dimensional video 14, which is a combination of these cross-sectional images, is displayed.

According to the third mode, only two space light modulators are required. Hence, a three-dimensional motion picture can be displayed by a simple configuration. Moreover, as in the case of the first embodiment, a uniform, clear, three-dimensional video can be displayed without limitations on a viewable direction.

[Fourth Mode]

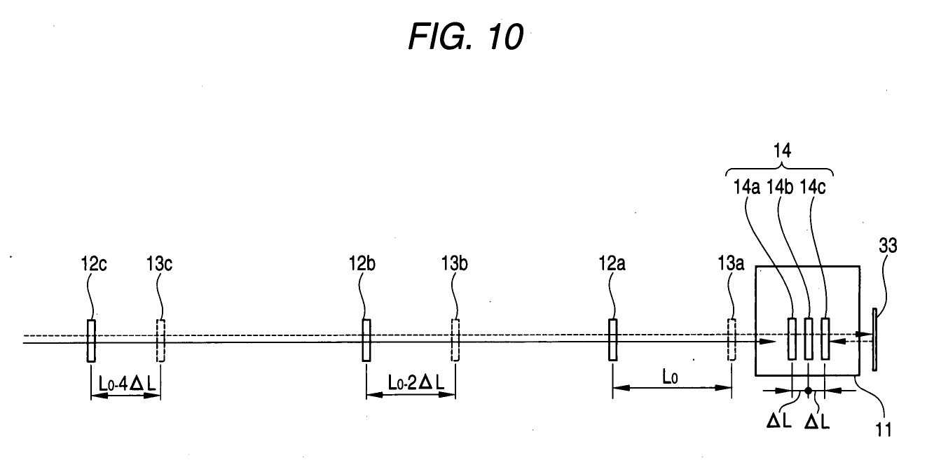

FIG. 10 shows a three-dimensional video display method according to a fourth mode of the present invention. The three-dimensional video display method of the fourth mode is for causing the first optical pulse 12 and the second optical pulse 13 to emit while being separated a given distance from each other. For instance, the second optical pulse 12 first enters the fluorescent space 11 and is reflected by the dielectric-substance mirror M provided in or outside the fluorescent space 11. The first optical pulse 12 and the second optical pulse 13 overlap each other at a position in the florescent space 11 opposing the location of the first optical pulse 12 whose entrance into the fluorescent space has been delayed, to thus induce fluorescence and provide the cross-sectional image 14. The first optical pulse 12 and the second optical pulse 13 are caused to enter the fluorescent space 11 by changing the distance between the first and second optical pulses, thereby inducing fluorescence at different positions within the fluorescent space 11. Thus, plural cross-sectional images 14a, 14b, and 14c are obtained, thereby displaying a three-dimensional video. Here, the distance between the first optical pulse 12 and the second optical pulse 13 is changed in increments of double the distance ΔL between the plural cross-sectional images 14a, 14b. As a result, the cross-sectional images 14a, 14b, or the like, are obtained at difference positions. Here, the repetitive cycle of the second optical pulse 13 that enters first is set so as to become longer than a duration in which the first optical pulse 12 that enters later completes a round trip within the fluorescent space 11 after having been reflected by the dielectric-substance mirror M.

(Display Operation Effected in the Fourth Mode)

The first optical pulses 12a, 12b, 12c, . . . and the second optical pulses 13a, 13b, 13c, . . . , which are separated a given distance from the respective first optical pulses 12a, 12b, 12c, . . . enter the fluorescent space 11 from one side thereof.

When the initial first optical pulse 12a and the second optical pulse 13a enter the fluorescent space 11, the preceding second optical pulse 13a enters the fluorescent space 11, passes through the same, undergoes reflection on the dielectric-substance mirror M, and again enters the fluorescent space 11. The cross-sectional image 14a appears at the location where the first optical pulse 12a and the second optical pulse 13a have overlapped each other. When the next second optical pulse 13b enters the fluorescent space 11, the preceding second optical pulse 13b undergoes reflection on the dielectric-substance mirror M. The cross-sectional image 14b appears at the position where the first optical pulse 12b and the second optical pulse 13b overlap each other. Similarly, the cross-sectional image 14c is displayed by means of the one-after-the-next first and second optical pulses 12c, 13c. The respective cross-sectional images 14a to 14c are displayed at different locations, whereby a single three-dimensional video 14, which is a combination of these cross-sectional images, is displayed.

According to the fourth mode, the method is suitable for a situation where a space is available on only one side of the fluorescent space 11.

So long as the dielectric-substance mirror M is used so as to permit transmission of a wavelength of fluorescence, observation of the three-dimensional video 14 from the point of the dielectric-substance M becomes feasible. Moreover, a three-dimensional fluorescent image can be prevented from being viewed while being reflected on the dielectric-substance mirror M.

When the wavelength of the first optical pulse 12 and that of the second optical pulse 13 differ from each other and when one of the first and second optical pulses induces intense two-photon absorption, the dielectric-substance mirror M permits transmission of a wavelength of the optical pulse which induces intense two-photon light absorption, thereby reflecting the remaining wavelength of the optical pulse that does not induce intense two-photon absorption. For this reason, there can be prevented occurrence of a drop in contrast, which would otherwise be caused when the optical pulse that induces intense two-photon absorption completes a round trip within the fluorescent substance.

The first optical pulse 12 may be caused to precede the second optical pulse, and may be caused to undergo reflection on the dielectric-substance mirror M. Further, the dielectric-substance mirror M may be a metal mirror.

### First Embodiment

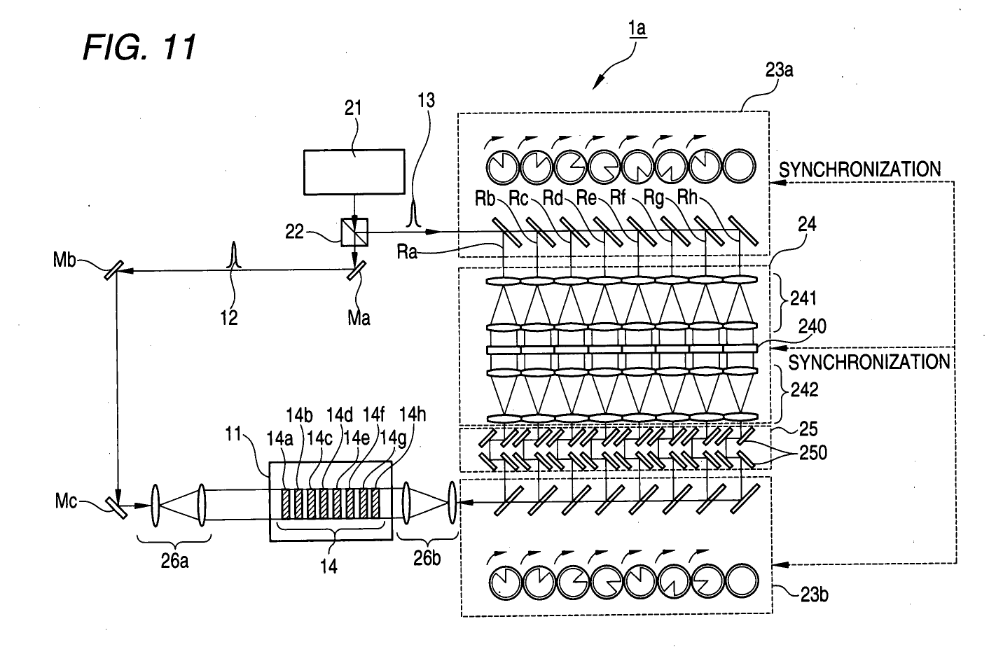

FIG. 11 shows a first embodiment of the present invention. A three-dimensional video display apparatus 1a of the first embodiment corresponds to the first mode. The three-dimensional video display apparatus 1a includes a pulse light source 21 for emitting an optical pulse at a given repetitive cycle, a beam splitter 22 which splits the optical pulse emitted from the pulse light source 21 into a first optical pulse 12 and a second optical pulse 13, a scale-up optical system 26a which causes the first optical pulse 12 split by the beam splitter 22 to enter one side of a fluorescent space 11 in a scaled-up manner by way of reflection mirrors Ma to Mc, a pair of rotary mirror sections 23a, 23b which are provided in preceding and subsequent stages of a space light modulation section 24 to be described later and which select, from optical paths Ra to Rh, any optical path for the second optical pulse 13 split by the beam splitter 22, a space light modulation section 24 for writing cross-sectional information into the second optical pulse 13 in accordance with the cross-sectional image signal, a delay optical path 25 for adjusting the optical path length for the second optical pulse 13, a scale-up optical system 26b which causes the second optical pulse 13 output from the rotary mirror section 23b to enter the other side of the fluorescent space 11 in a scaled-up manner, and an unillustrated control section for controlling individual sections of the apparatus. Details of the rotary mirror sections 23a, 23b will be described later.

An optical pulse laser having a time width of 100 femtoseconds, a repetitive frequency of 1 kHz, and a wavelength of 800 nm is used for the pulse light source 21.

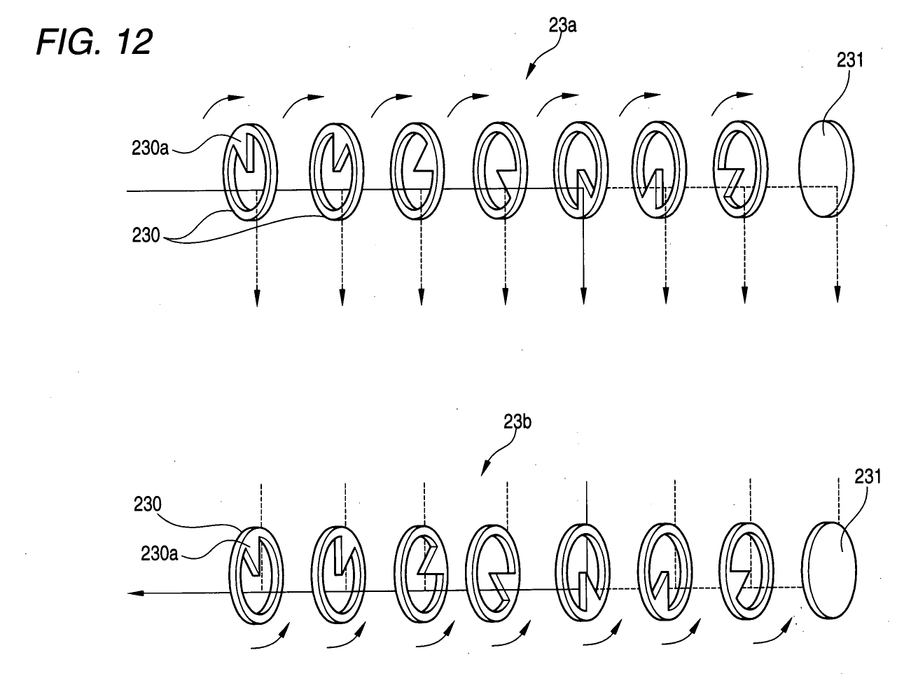

FIG. 12 shows details of the pair of rotary mirror sections 23a, 23b. An entrance-side rotary mirror section 23a has plural optical paths, as well as having the function of an optical path switching section for distributing an entered optical pulse by sequentially switching the plural optical paths. The rotary mirror section 23a includes plural disk-like rotary mirrors 230, and one fixed mirror 231 disposed at the end of a line. Each of the rotary mirrors 230 has a triangular mirror section 230a which can block the optical axis of the optical pulse 13 and allows passage of the optical pulse 13 in accordance with a rotary angle. The plural rotary mirrors 230 are rotated with a predetermined phase difference. When the triangular mirror section 230a of any one of the rotary mirrors 230 blocks the optical pulse 13, the rotary mirror 230 reflects the optical pulse 13, to thus change the course of the optical pulse 13 toward a desired optical axis. Accordingly, a desired optical path for the second optical pulse 13 can be selected from the optical paths Ra to Rh by means of controlling a timing at which the optical pulse 13 passes and a timing at which the rotary mirror 230 rotates.

The rotary mirror section 23b has the same configuration as that of the above-described rotary mirror section 23a, but is on the reflection side rather than on the entrance side. The rotary mirror section 23b has the function of an optical axis alignment optical system for aligning optical axes of the plural entered second optical pulses with each other. Since there is a necessity for reflecting the entered optical pulse in a single optical axis without fail, the rotary mirror section 23a and the rotary mirror section 23b rotate synchronously, as shown in FIG. 12.

The space light modulation section 24 has a space light modulator 240, a scale-up optical system 241 disposed in front of the space light modulator 240, and a scale-down optical system 242 disposed subsequent to the space light modulator 240, all of which are disposed in the optical paths Ra to Rh selected by the rotary mirror section 23a.

The delay optical path 25 adjusts the optical path length for the second optical pulse 13 traveling through the respective optical paths Ra to Rh of the space light-modulation section 24, thereby adjusting the interval between the second optical pulse 13. Plural reflection mirrors 250 are disposed at appropriate positions.

An unillustrated control section executes control to synchronize selection of any one from the optical paths Ra to Rh performed by the rotary mirror section 23a, writing of cross-sectional information performed by the space light modulator 240, and alignment of optical axes performed by the rotary mirror section 23b.

The fluorescent space 11 is filled with an organic solvent into which a Rhodamine pigment is dissolved. The Rhodamine pigment is known as a fluorescent pigment which satisfies Expressions (1), (2), and (3) under conditions of: λ₁=800 nm and λ₂=800 nm and has a high two-photon fluorescence efficiency.

(Display Operation Effected in the First Embodiment)

The optical pulse emitted from the pulse light source 21 is split by the beam splitter 22 into the first optical pulse 12 and the second optical pulse 13. The first optical pulse 12 proceeds toward the fluorescent space 11 by way of the reflection mirrors Ma to Mc, and the second optical pulse 13 proceeds toward the rotary mirror section 23a.

The rotary mirror section 23a periodically allocates the optical paths Ra to Rh to the second optical pulse 13 on a per-pulse basis. Subsequently, the space light modulation section 24 writes cross-sectional information into the second optical pulse 13, and the delay optical path 25 adjusts the optical path length of the second optical pulse 13. Thereafter, the rotary mirror section 23b returns the second optical pulse 13 to the fluorescent space 11.

After beam sizes of the first and second optical pulses 12, 13 have been scaled-up by the scale-up optical systems 26a, 26b, the first and second optical pulses 12, 13 enter the fluorescent space 11 from opposite directions. Fluorescence arises at the position where the first and second optical pulses 12, 13 overlap each other, to thus display a cross-sectional image.

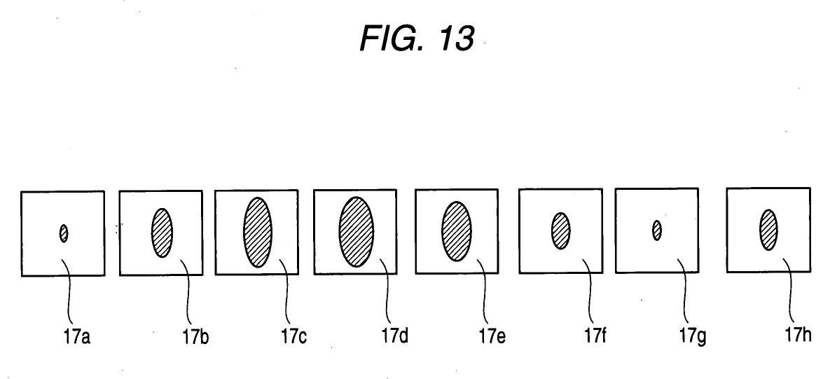

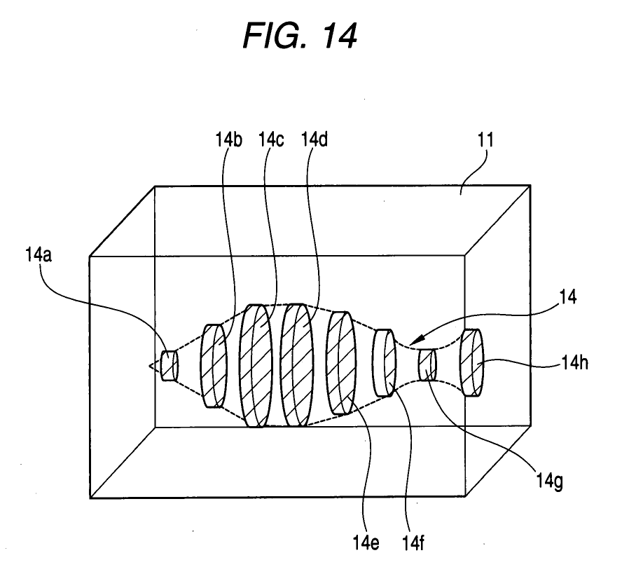

FIG. 13 shows cross-sectional information to be written into the second optical pulse 13, and FIG. 14 shows a cross-sectional image and a three-dimensional video. Pieces of cross-sectional information 17a to 17h shown in FIG. 13 are to be written into the respective second optical pulses 13 allocated to the optical paths Ra to Rh. When the first optical pulse 12 and the second optical pulse 13—having undergone writing of the pieces of cross-sectional information 17a to 17h and having been allocated to the optical paths Ra to Rh—overlap each other within the fluorescent space 11, cross-sectional images 14a to 14h appear, as shown in FIG. 14. These cross-sectional images 14a to 14h are displayed as the three-dimensional video 14.

According to the first embodiment, the rotary mirror section 23a which distributes the second optical pulse 13 by switching the optical paths Ra to Rh is used as the distribution section for distributing the second optical pulse 13. Hence, utilization efficiency of light becomes higher, and a highly-bright three-dimensional video can be displayed.

### Second Embodiment

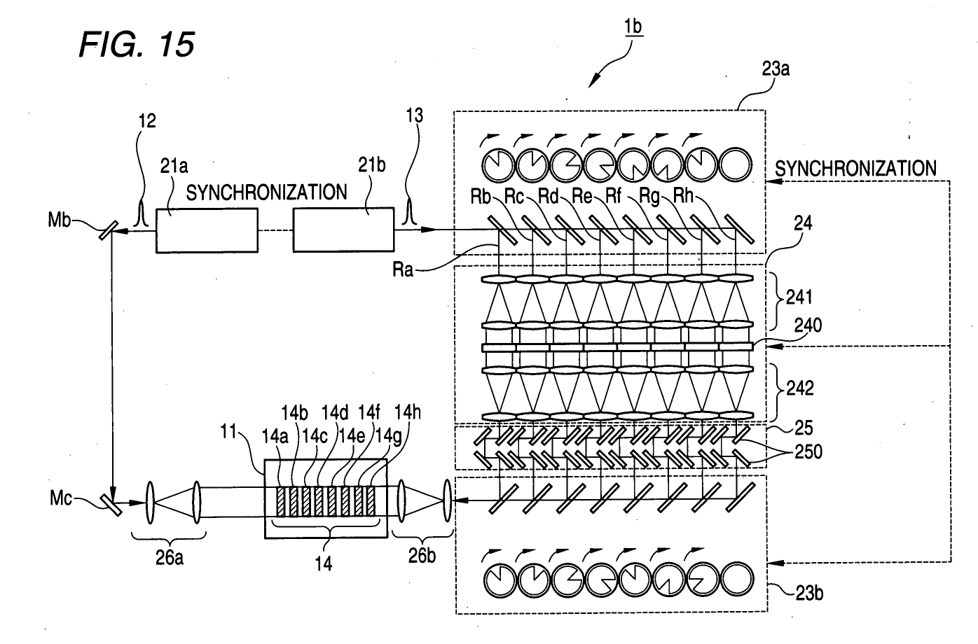

FIG. 15 shows a second embodiment of the present invention. A three-dimensional video display apparatus 1b of the second embodiment corresponds to the first mode. In connection with the configuration of the first embodiment, first and second pulse light sources 21a, 21b which emit the first and second optical pulses 12, 13 of different wavelengths are used as the pulse light sources, and the fluorescent space 11 compatible with the first and second optical pulses 12, 13 is also used. In other respects, the second embodiment is configured in the same manner as is the first embodiment.

An optical pulse laser having a time width of 100 femtoseconds, a repetitive frequency of 1 kHz, and a wavelength of 800 nm is used for the first pulse light source 21a. An optical pulse laser having a time width of 100 femtoseconds, a repetitive frequency of 1 kHz, and a wavelength of 1400 nm is used for the second pulse light source 21b. These two pulse light sources 21a, 21b are configured to synchronously emit optical pulses.

The fluorescent space 11 is filled with an organic solvent into which a Rhodamine pigment is dissolved. The Rhodamine pigment is known as a fluorescent pigment which satisfies Expressions (1), (2), (3), and (6) under conditions of: λ₁=800 nm and λ₂=1400 nm and has a high two-photon fluorescence efficiency. The intensity of the optical pulse of 1400 nm is made sufficiently stronger than that of the optical pulse of 800 nm.

(Display Operation Effected in the Second Embodiment)

The first optical pulse 12 that has been emitted from the first pulse light source 21a and has a wavelength of 800 nm proceeds toward the fluorescent space 11 by way of the reflection mirrors Ma, Mb. Meanwhile, the second optical pulse 13 that has been emitted from the second pulse light source 21b and has a wavelength of 1400 nm proceeds toward the rotary mirror section 23a.

The rotary mirror section 23a periodically allocates the optical paths Ra to Rh to the second optical pulse 13 on a per-pulse basis. Subsequently, the space light modulation section 24 writes cross-sectional information into the second optical pulse 13, and the delay optical path 25 adjusts the optical path length for the second optical pulse 13. Thereafter, the rotary mirror section 23b returns the second optical pulse 13 to the fluorescent space 11.

After beam sizes of the first and second optical pulses 12, 13 have been scaled-up by the scale-up optical systems 26a, 26b, the first and second optical pulses 12, 13 enter the fluorescent space 11 from opposite directions. Fluorescence arises at the position where the first and second optical pulses 12, 13 overlap each other, to thus display a cross-sectional image. In this way, a cross-sectional image is displayed at a high ON/OFF ratio as a result of the optical pulse 12 having a wavelength of 800 nm and the optical pulse 13 having a wavelength of 1400 nm overlapping each other within the fluorescent space 11 along a single optical axis in opposite directions. As in the case of the first embodiment, the cross-sectional images 14a to 14h appear in the fluorescent space 11, as shown in FIG. 14. These cross-sectional images are displayed as the three-dimensional video 14.

According to the second embodiment, as in the case of the first embodiment, the first and second optical pulses 12, 13 of different wavelengths are used, and the rotary mirror section 23a having a high utilization efficiency of light is used. Accordingly, a high-contrast, highly-bright, and clear three-dimensional video can be displayed.

### Third Embodiment

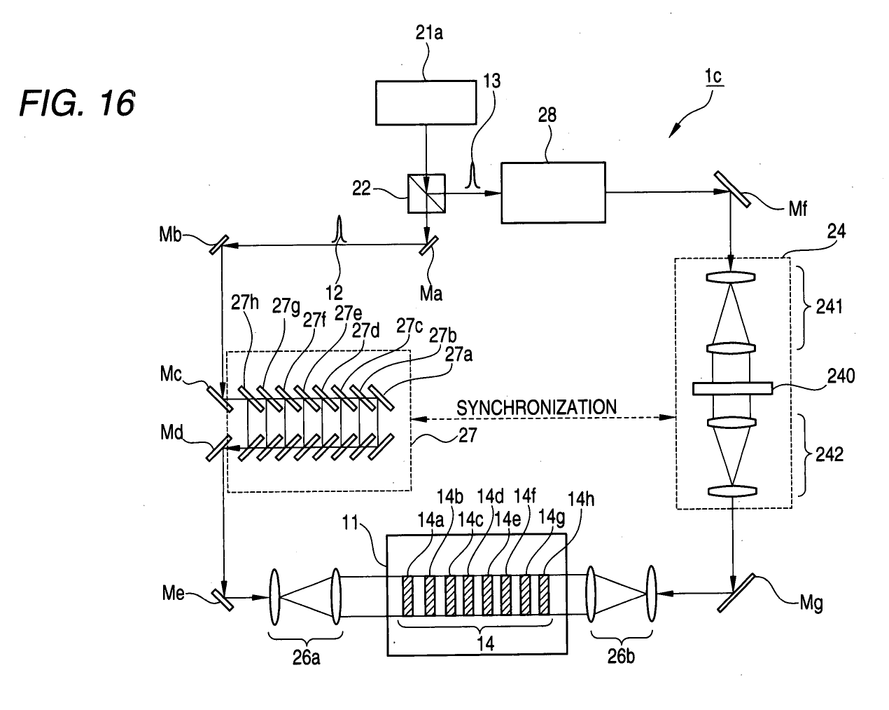

FIG. 16 shows a third embodiment of the present invention. A three-dimensional video display apparatus 1c of the third embodiment corresponds to the first mode, and excites optical pulses of different wavelengths. The three-dimensional video display apparatus 1c includes a pulse light source 21 for emitting an optical pulse at a given repetitive cycle, a beam splitter 22 which splits the optical pulse emitted from the pulse light source 21 into a first optical pulse 12 and a second optical pulse 13, an optical path length control mechanism 27 for changing an optical path length for the first optical pulse 12, a wavelength converter 28 for changing the wavelength of the second optical pulse 13, a space light modulation section 24 for writing cross-sectional information, which corresponds to across-sectional image signal, into the second optical pulse 13, a pair of scale-up optical systems 26a, 26b which scale-up the beam sizes of the respective first and second optical pulses 12, 13 and cause the first and second optical pulses 12, 13 to enter the fluorescent space 11, and an unillustrated control section for controlling individual sections of the apparatus. In FIG. 16, reference symbols Ma to Mg denote reflection mirrors.

An optical pulse laser having a time width of 100 femtoseconds, a repetitive frequency of 1 kHz, and a wavelength of 800 nm is used for the pulse light source 21.

The wavelength converter 28 converts the second optical pulse 13 split by the beam splitter 22 from a wavelength of 800 nm to a wavelength of 1400 nm.

The optical path length control mechanism 27 is configured in the same manner as is the optical path length control mechanism 15 shown in FIG. 7, and includes eight switching mirrors 27a to 27h, each of which consists of a combination of a pair of mirrors.

The fluorescent space 11 is filled with an organic solvent into which a Rhodamine pigment is dissolved. The Rhodamine pigment is known as a fluorescent pigment which satisfies Expressions (1), (2), (3), and (6) under conditions of: λ₁=800 nm and λ₂=1400 nm and has a high two-photon fluorescence efficiency. The intensity of the optical pulse of 1400 nm is made sufficiently stronger than that of the optical pulse of 800 nm.

(Display Operation Effected in the Third Embodiment)

The optical pulse 21 that has been emitted from the pulse light source 21 and has a wavelength of 800 nm is split by the beam splitter 22 into the first optical pulse 12 and the second optical pulse 13. The first optical pulse 12 enters the optical path length control mechanism 27 by way of the reflection mirrors Ma to Mc. After the optical path length for the first optical pulse 12 has been periodically switched by the optical path length control mechanism 27, the first optical pulse 12 proceeds toward the fluorescent space 11 by way of the reflection mirrors Md, Me.

After the wavelength converter 28 has converted the other second optical pulse 13 split by the beam splitter 22 from a wavelength of 800 nm to a wavelength of 1400 nm, the second optical pulse 13 enters the space light modulation section 24 by way of the reflection mirror Mf, and the space light modulation section 24 writes cross-sectional information into the second optical pulse 13. At this time, the optical path length control mechanism 27 and the space light modulation section 24 are controlled so as to become synchronized. For this reason, as a result of the optical path length control mechanism 27 adjusting the optical path length for the first optical pulse 12, the location where the two optical pulses overlap each other is adjusted to a desired location. The space light modulation section 24 writes, into the second optical pulse 13, information about a cross-sectional image to be displayed at that location. The second optical pulse 13 output from the space light modulation section 24 enters the scale-up optical system 26 by way of the reflection mirror Mg.

The scale-up optical systems 26a, 26b scale-up the beam sizes of the respective first, second optical pulses 12, 13. Subsequently, the optical pulses 12, 13 enter the fluorescent space 11 from opposite directions, and fluorescence arises at a position where the two optical pulses overlap each other, to thus display the cross-sectional images 14a to 14h. As mentioned above, a cross-sectional image is displayed at a high ON/OFF ratio as a result of the optical pulse 12 having a wavelength of 800 nm and the optical pulse 13 having a wavelength of 1400 nm overlapping each other within the fluorescent space 11 along a single optical axis and entering from opposite directions. As in the case of the previous embodiments, the cross-sectional images 14a to 14h appear in the fluorescent space 11, as shown in FIG. 14. These cross-sectional images are displayed as the three-dimensional video 14.

According to the third embodiment, since the first and second optical pulses 12, 13 of different wavelengths are used, a high-contrast three-dimensional video can be displayed. Moreover, only one space light modulator is required, and hence the configuration of the three-dimensional video display apparatus can be simplified.

### Fourth Embodiment

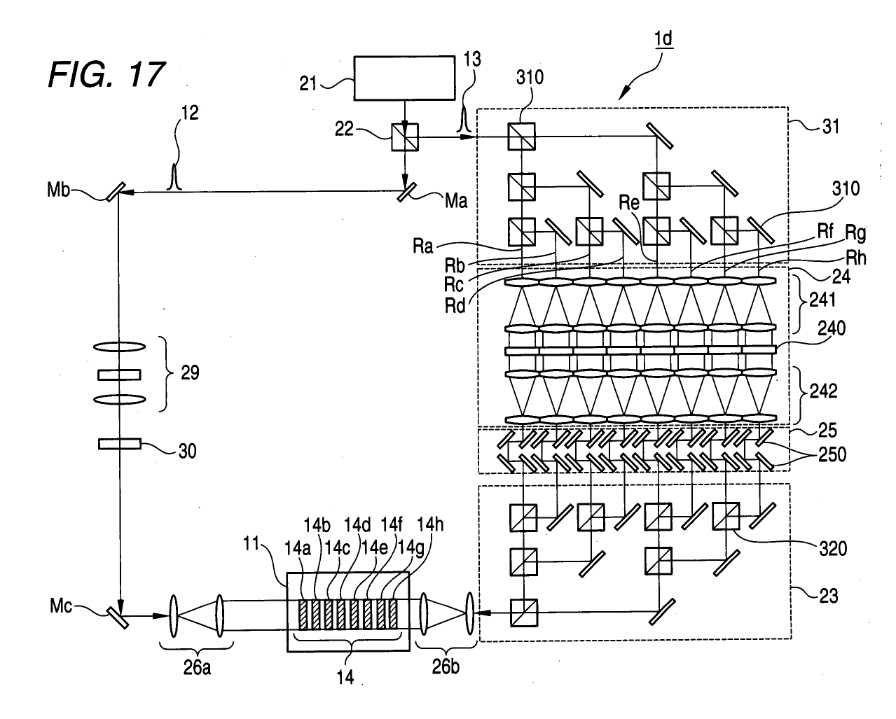

FIG. 17 shows a fourth embodiment of the present invention. A three-dimensional video display apparatus 1d of the fourth embodiment corresponds to the second mode, and excites optical pulses of different wavelengths. The three-dimensional video display apparatus 1d includes a pulse light source 21 for emitting an optical pulse at a given repetitive cycle, a beam splitter 22 which splits the optical pulse emitted from the pulse light source 21 into a first optical pulse 12 and a second optical pulse 13, an SHG crystal 29 for converting the wavelength of the first optical pulse 12, a filter 30, a split optical system 31 for splitting the second optical pulse 13 into plural second optical pulses 13 equal in number to the cross-sectional images, the space light modulation section 24 for writing cross-sectional information into the second optical pulse 13 in accordance with the cross-sectional image signal, a delay optical path 25 for adjusting the optical path length for the second optical pulse 13, an optical axis alignment optical system 32 for aligning optical axes of the plural second optical pulses 13 with each other, a pair of scale-up optical systems 26a, 26b which scale-up beam sizes of the first and second optical pulses 12, 13 and cause the first and second optical pulses 12, 13 to enter the fluorescent space 11, and an unillustrated control section for controlling individual sections of the apparatus.

An optical pulse laser having a time width of 100 femtoseconds, a repetitive frequency of 1 kHz, and a wavelength of 800 nm is used for the pulse light source 21.

The SHG crystal 29 converts the first optical pulse 12 from a wavelength of 800 nm to a wavelength of 400 nm, and the filter 30 blocks light of different wavelengths, to thus allow passage of only the first optical pulse 12 having a wavelength of 400 nm.

The fluorescent space 11 is filled with a fluorescent substance which satisfies Expressions (1), (2), (3), and (6) under conditions of: λ₁=400 nm and λ₂=800 nm.

The split optical system 31 splits the second optical pulse 13 into plural second optical pulses 13 equal in number to the cross-sectional images 14a to 14h, through use of plural beam splitters 310 and plural reflection mirrors 311.

The optical axis alignment optical system 32 aligns the plural second optical pulses 13 to a single optical axis, through use of plural beam splitters 320 and plural reflection mirrors 321.

(Display Operation Effected in the Fourth Embodiment)

The optical pulse emitted from the pulse light source 21 is split into the first optical pulse 12 and the second optical pulse 13 by means of the beam splitter 22. The SHG crystal 29 converts the first optical pulse 12 from a wavelength of 800 nm to a wavelength of 400 nm. After having passed through the filter 30, the first optical pulse 12 proceeds toward the fluorescent space 11.

After the split optical system 31 has split the second optical pulse 13 into plural optical paths (eight in FIG. 17), the space light modulation section 24 writes the cross-sectional information into the respective optical pulses 13.

Subsequently, the respective second optical pulses 13 travel via the delay optical path 25. As a result, timings at which the second optical pulses 13 enter the fluorescent space are adjusted by means of changes in optical path lengths for the respective second optical pulses 13. The optical axis alignment optical system 32 again superimposes the second optical pulses 13 on the single optical axis. At this time, the optical path lengths over which the respective optical pulses 13 have traveled differ from each other. Hence, the optical pulses do not overlap each other, and a single optical pulse train is eventually obtained.

The beam size of the optical pulse train, consisting of the plural thus-obtained second optical pulses 13, is scaled-up by the scale-up optical system 26b, and the optical pulse train then enters one side of the fluorescent space 11. The beam size of the first optical pulse 12 is also scaled-up by the scale-up optical system 26a, and the first optical pulse 12 enters the other side of the fluorescent space 11. The first optical pulse 12 and the optical pulse train consisting of the plural second optical pulses 13, which have entered from opposite directions, overlap each other, whereupon the respective cross-sectional images 14a to 14h appear within the fluorescent space 11. As in the case of other embodiments, the cross-sectional images 14a to 14h appear in the fluorescent space 11, and are displayed as the three-dimensional video 14.

According to the fourth embodiment, the first and second optical pulses 12, 13 having different wavelengths are used. Hence, a high-contrast three-dimensional video can be displayed. Moreover, a three-dimensional motion picture can be displayed by rewriting cross-sectional information on a per-optical-pulse-train basis.

### Fifth Embodiment

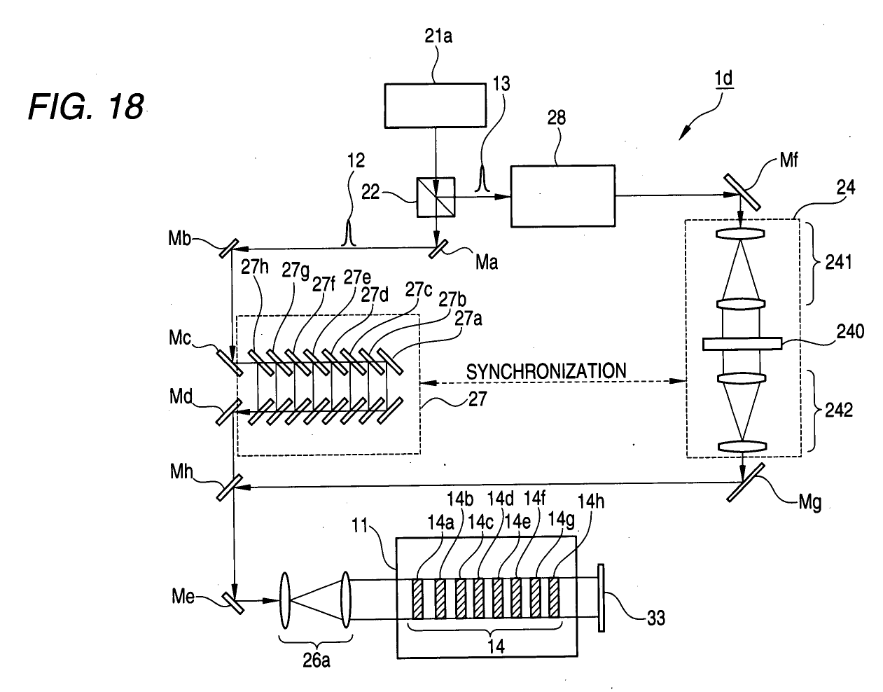

FIG. 18 shows a fifth embodiment of the present invention. A three-dimensional video display device 1e of a fifth embodiment corresponds to the fourth mode. The first optical pulse 12 and the second optical pulse 13 are emitted while being spaced a predetermined distance from each other. One of the two optical pulses enters first, and is reflected by the dielectric-substance mirror M. Subsequently, the thus-reflected optical pulse is superimposed on the optical pulse having entered later in a mutually-opposing manner, thereby inducing fluorescence. Thus, a cross-sectional image is acquired.

The three-dimensional video display apparatus 1e includes a pulse light source 21 for emitting an optical pulse at a given repetitive cycle, a beam splitter 22 which splits the optical pulse emitted from the pulse light source 21 into a first optical pulse 12 and a second optical pulse 13, an optical path length control mechanism 27 for changing an optical path length for the first optical pulse 12, a wavelength converter 28 for changing the wavelength of the second optical pulse 13, a space light modulation section 24 for writing cross-sectional information, which corresponds to a cross-sectional image signal, into the second optical pulse 13, a scale-up optical system 26a which merges the first and second optical pulses 12, 13 and causes the thus-merged optical pulse to enter the fluorescent space 11, dielectric-substance mirrors Ma to Mh for reflecting a preceding optical pulse component of the thus-merged optical pulse, and an unillustrated control section for controlling individual sections of the apparatus. In FIG. 18, reference symbols Ma to Mh denote reflection mirrors.

A dielectric-substance mirror-which reflects light having a wavelength of, e.g., 1400 nm and permits passage of light having a wavelength of 800 nm—is used for the dielectric-substance mirror M.

An optical pulse laser having a time width of 100 femtoseconds, a repetitive frequency of 1 kHz, and a wavelength of 800 nm is used for the pulse light source 21.

The wavelength converter 28 is for converting the second optical pulse 13 split by the beam splitter 22 from a wavelength of 800 nm to a wavelength of 1400 nm.

The optical path length control mechanism 27 is configured in the same manner as is the optical path length control mechanism 15 shown in FIG. 7, and has eight switching mirrors 27a to 27h, each of which is a combination of a pair of mirrors.

The fluorescent space 11 is filled with an organic solvent into which a Rhodamine pigment is dissolved. The Rhodamine pigment is known as a fluorescent pigment which satisfies Expressions (1), (2), (3), and (6) under conditions of: λ₁=800 nm and λ₂=1400 nm and has a high two-photon fluorescence efficiency. The intensity of the optical pulse of 1400 nm is made sufficiently stronger than that of the optical pulse of 800 nm.

(Display Operation Effected in the Fifth Embodiment)

The optical pulse that has been emitted from the pulse light source 21 and has a wavelength of 800 nm is split into the first optical pulse 12 and the second optical pulse 13 by means of the beam splitter 22. The first optical pulse 12 enters the optical path length control mechanism 27 by way of the reflection mirrors Ma to Mc. After the optical path length of the first optical pulse 12 has periodically been switched by the optical path length control mechanism 27, the first optical pulse 12 proceeds to the fluorescent space 11 by way of the reflection mirrors Md, Mh, and Me.

The wavelength converter 28 converts the other second optical pulse 13 split by the beam splitter 22 from a wavelength of 800 nm to a wavelength of 1400 nm. Subsequently, the second optical pulse 13 enters the space light modulation section 24 by way of the reflection mirror Mf, and the space light modulation section 24 writes cross-sectional information into the second optical pulse 13. At this time, the optical path length control mechanism 27 and the space light modulation section 24 are controlled so as to become synchronized. Accordingly, the optical path length of the first optical pulse 12 is adjusted by the optical path length control mechanism 27. As a result, the location where the two optical pulses overlap each other is adjusted to a desired location. The space light modulation section 24 writes, into the second optical pulse 13, information about a cross-sectional image to be displayed at that location. The second optical pulse 13 output from the space light modulation section 24 enters the scale-up optical system 26b while being spaced a predetermined distance from the first optical pulse 12 by way of the reflection mirror Mh.

After the beam sizes of the first and second optical pulses 12, 13 have been scaled-up by the scale-up optical system 26a, the first and second optical pulses 12, 13 enter the fluorescent space 11 from the same side thereof while being spaced a predetermined distance away from each other. The preceding second optical pulse 13 undergoes reflection on the reflection mirror M. Fluorescence arises at a position where the reflected light and the first optical pulse 12 overlap each other, whereupon the cross-sectional images 14a to 14h appear. As mentioned above, the optical pulses having wavelengths of 1400 nm and 800 nm are superimposed one on the other along the single optical axis and run in opposite directions within the fluorescent space 11, whereby the cross-sectional images are displayed at a high ON/OFF ratio. As in the case of the other embodiments, the cross-sectional images 14a to 14h appear within the fluorescent space 11, as shown in FIG. 18. These cross-sectional images are displayed as the three-dimensional video 14.

According to the fifth embodiment, the first and second optical pulses 12, 13 having different wavelengths are used. Therefore, a high-contrast three-dimensional video can be displayed. Moreover, only one scale-up optical system is required, and hence the configuration of the three-dimensional video display can be simplified.

The present invention is not limited to the above-described modes and the respective embodiments and is susceptible to various modifications without changing the scope of gist of the invention. For instance, constituent elements of the respective modes and those of the respective embodiments can be arbitrarily combined together without changing the scope of gist of the present invention.

According to the three-dimensional video display method and apparatus, the first optical pulse and the second optical pulse are caused to overlap each other in the fluorescent space, thereby inducing intensive multi-photon absorption solely at a position where the optical pulses overlap each other, to thus emit fluorescence. Consequently, the position in the fluorescent space where the first optical pulse and the second optical pulse overlap each other can be changed, by controlling timings at which the first and second optical pulses enter the fluorescent space. A three-dimensional video formed from plural cross-sectional images can be displayed by means of inducing fluorescence at plural positions.

According to this invention, a uniform, clear, three-dimensional video can be displayed without limitation on a viewable direction.

The entire disclosure of Japanese Patent Application No. 2005-054223 filed on Feb. 28, 2005 including specification, claims, drawings and abstract in incorporated herein by reference in its entirety.

What is claimed is:

1. A three-dimensional video display method comprising:
a first step of causing a first optical pulse to enter a fluorescent space from a predetermined direction; and
a second step of causing a second optical pulse, into which cross-sectional information is written, to enter the fluorescent space from a direction opposite to the predetermined direction, to induce fluorescence at a position in the fluorescent space where the first optical pulse and the second optical pulse overlap each other.

2. The three-dimension video display method according to claim 1,
wherein the first and second steps include inducing fluorescence at a plurality of the positions within the fluorescent space by controlling timings at which the first and second optical pulses enter the fluorescent space.

3. The three-dimension video display method according to claim 1,
wherein the first step includes causing the first optical pulse to enter the fluorescent space at a predetermined repetitive cycle; and
the second step includes causing the second optical pulse to enter the fluorescent space at a repetitive cycle, which is different from the predetermined repetitive cycle, and inducing fluorescence at the plurality of positions within the fluorescent space.

4. The three-dimension video display method according to claim 1,
wherein the second step includes causing a plurality of the second optical pulses to enter the fluorescent space at a predetermined repetitive cycle with respect to the single first optical pulse, to induce fluorescence at the plurality of positions within the fluorescent space.

5. The three-dimension video display method according to claim 1,
wherein the first step includes causing the plurality of first optical pulses to enter the fluorescent space at a predetermined repetitive cycle; and
the second step includes causing a plurality of pulse trains, each of which is formed from N of the second optical pulses, to enter the fluorescent space at the same repetitive cycle as the predetermined repetitive cycle, thereby inducing fluorescence at the N positions within the florescent space.

6. The three-dimension video display method according to claim 1,
wherein the first step includes causing M of the first optical pulses to enter the fluorescent space at a predetermined repetitive cycle; and
the second step includes causing M pulse trains, each of which is formed from N of the second optical pulses, to enter the fluorescent space at the same repetitive cycle as the predetermined repetitive cycle, to induce fluorescence at the N×M positions within the fluorescent space.

7. The three-dimension video display method according to claim 1,
wherein the first and second optical pulses which enter the fluorescent space are of different wavelengths.

8. The three-dimensional video display method according to claim 1,
wherein the writing of the cross-sectional information into the second optical pulse is performed through space light modulation.

9. The three-dimensional video display method according to claim 1,
wherein the first or second step include reflecting a preceding optical pulse of the first and second optical pulses, thereby causing the first and second optical pulses to enter the fluorescent space from opposite directions each other.

10. A three-dimensional video display apparatus comprising:
a first optical pulse entrance unit that causes a first optical pulse to enter a fluorescent space from a predetermined direction; and
a second optical pulse entrance unit that causes a second optical pulse, into which cross-sectional information has been written, to enter the fluorescent space from a direction opposite to the predetermined direction, to induce fluorescence at a position within the fluorescent space where the first optical pulse and the second optical pulse overlap each other.

11. The three-dimensional video display apparatus according to claim 10,
wherein the first and second optical pulse entrance units includes:
one optical pulse light source that emits an optical pulse; and
a split optical system which splits the optical pulse emitted from the optical pulse light source into two optical pulses, one of the two optical pulses being the first optical pulse, and a remaining optical pulse being a second optical pulse into which the cross-sectional information is to be written.

12. The three-dimensional video display apparatus according to claim 10,
wherein the first optical pulse entrance unit has a first optical pulse light source that emits the first optical pulse, and
the second optical pulse entrance unit has a second optical pulse light source that emits a second optical pulse into which the cross-sectional information is to be written.

13. The three-dimensional video display apparatus according to claim 10,
wherein the second optical pulse entrance unit has a space light modulator which writes the cross-sectional information into an optical pulse in accordance with a cross-sectional image signal to generate the second optical pulse.

14. The three-dimensional video display apparatus according to claim 13,
wherein the space light modulator is a liquid-crystal space light modulator.

15. The three-dimensional video display apparatus according to claim 10,
wherein the second optical pulse entrance unit includes:
a plurality of optical paths of different lengths;
a distribution section which distributes an entered optical pulse into the plurality of optical paths;
a plurality of space light modulators which are provided in the plurality of optical paths and which write cross-sectional information into a plurality of optical pulses distributed into the plurality of optical paths; and
an optical axis alignment optical system which aligns, with each other, optical axes of the plurality of second optical pulses into which the cross-sectional information is written, thereby causing the plurality of second optical pulses to enter the fluorescent space.

16. The three-dimensional video display apparatus according to claim 15,
wherein the distribution section includes an optical path switching section that distributes an entered optical pulse by sequentially switching the plurality of optical paths.

17. The three-dimensional video display apparatus according to claim 15,
wherein the distribution section is a split optical system which splits an entered optical pulse into a plurality of optical pulses and distributes the split optical pulses into the plurality of optical paths.

18. The three-dimensional video display apparatus according to claim 10,
wherein the first optical pulse entrance unit has an optical path length control section which generates the plurality of first optical pulses by controlling an optical path length of the first optical pulse.

19. The three-dimensional video display apparatus according to claim 10,
wherein the first or second optical pulse entrance unit has a wavelength converter that converts a wavelength of an optical pulse.

20. The three-dimensional video display apparatus according to claim 10,
wherein the first and second optical pulse entrance units have a pair of scale-up optical systems which enlarges apertures of the first and second optical pulses to cause the first and second optical pulses to enter the fluorescent space.

21. The three-dimensional video display apparatus according to claim 10,
wherein the fluorescent space is formed from a fluorescent substance transparent to wavelengths of the first and second optical pulses, or a gas, liquid, or solid which includes the fluorescent substance.

22. The three-dimensional video display apparatus according to claim 10,
wherein the most intensive multi-photon absorption arises at the position in the fluorescent space where the first optical pulse and the second optical pulse overlap each other.

23. The three-dimensional video display apparatus according to claim 10,
wherein the first and second optical pulse entrance units cause the first and second optical pulses of different wavelengths to enter the fluorescent space.

24. The three-dimensional video display apparatus according to claim 23,
wherein the most intensive multi-photon absorption arises at the position in the fluorescent space, where the first optical pulse and the second optical pulse overlap each other, as a result of two or more the first and second optical pulses of different wavelengths overlap each other.

25. The three-dimensional video display apparatus according to claim 23,
wherein the first and second optical pulse entrance units include:
an optical pulse of a shorter wavelength, among the first and second optical pulses of different wavelengths, being lower in light intensity than an optical pulse of a longer wavelength;
the fluorescent space being transparent to the first and second optical pulses; and
an excitation energy to a two-photon absorption level in the fluorescent space being larger than energy of two photons of the optical pulse of a longer wavelength and equal to or smaller than energy determined by addition of one photon of the optical pulse of a shorter wavelength.

26. The three-dimensional video display apparatus according to claim 10,
wherein the first or second optical pulse entrance unit has a mirror that causes the first optical pulse and the second optical pulse to enter the fluorescent space from opposite directions by reflecting a preceding optical pulse of the first and second optical pulses.
